(19) United States
(12) Patent Application Publication
(10) Pub. No.: US 2016/0092799 A1
(43) Pub. Date: Mar. 31, 2016

(54) ANALYTICS WORKBENCH

(71) Applicant: SYNTEL, INC., Troy, MI (US)

(72) Inventors: Aminur R. Khan, Mumbai (IN); Kavya Chandrasekaran, Chennai (IN); Sfurti Kolhapure, Mumbai (IN)

(21) Appl. No.: 14/501,860

(22) Filed: Sep. 30, 2014

(51) Int. Cl. G06Q 10/06; G06F 3/0484; G06F 17/30; G06F 3/0482

(52) U.S. Cl. CPC G06Q 10/063; G06F 3/0482; G06F 3/04842; G06F 17/30126

(57) ABSTRACT

An article of manufacture may include a non-transitory computer storage medium having a computer program for determining a solution to a business problem selected by a user interacting with a graphical user interface (GUI) displayed on a display device. Determining the solution may include processing an input dataset including values corresponding to variables, the processing configured to identify a list of the variables from the input dataset. The computer program may be configured for receiving from the user via the GUI a selection variable, selectively displaying a business problem-specific parameter, displaying a list of candidate analytical methods associated with the selected business problem, wherein the GUI permits the user to select and/or confirm at least one of the candidate analytical methods, configuring the model according to user selections, and analyzing the input dataset according to the model to determine the solution to the business problem.

### BACKGROUND

a. Technical Field

The present disclosure relates to a system, method, and article of manufacture configured to facilitate, using a graphical user interface, a user's configuration of an analytical model suitable for use in determining a solution to a business problem.

b. Background Art

This background description is set forth below for the purpose of providing context only. Therefore, any aspects of this background description, to the extent that it does not otherwise qualify as prior art, is neither expressly nor impliedly admitted as prior art against the instant disclosure.

The functionality available via statistical analysis and modeling applications and programs continues to increase. Such applications and programs are therefore used in a broad range of industries, including business. Conventional statistical analysis and modeling computer applications, however, have shortcomings. For example, conventional applications typically require a significant understanding of statistics, programming techniques, data manipulation and the like in order to setup the analysis/modeling program to perform the desired analysis. Accordingly, the technical requirements of the programs alone can prevent some users from taking full advantage of all the available functionality of the programs. For example, a typical business user may not have the requisite background or experience in one or more of the technical areas noted above. Accordingly, use of these applications and programs may be impaired, or the user (or the organization employing the user) may need to retain a specialist to assist in the use of these programs. In other words, the foregoing challenges can sometimes deter typical business users from analyzing the data at all, or alternatively require the assistance of a professional user (e.g., a statistician or data scientist) at additional cost. While there has been some improvement in the user interface of such applications to assist the user with data analysis and modeling, challenges continue to exist.

Additionally, typical users and/or organizations often are forced to purchase expensive software suites that include not only the statistical and modeling aspects they are interested in, but also include additional capabilities to perform an wide variety of other tasks. However, the typical user may not use, or only infrequently use, these additional features. Accordingly, users in this scenario may incur a cost for unused functionality.

There is, therefore, a need for solutions that minimize or eliminate one or more of the above-described shortcomings. The foregoing discussion is intended only to illustrate the present field and should not be taken as a disavowal of claim scope.

### SUMMARY

In an embodiment, an article of manufacture is provided that includes a non-transitory computer storage medium having a computer program encoded thereon that when executed by a processor in a computing device dynamically configures a model for use in determining a solution to a business problem. The business problem is one that is selected by a user interacting with a graphical user interface (GUI) displayed on a display device connected to the computing device. The computer program includes code for processing an input dataset having data organized to a list of variables that may be defined by the business problem selected, wherein the processing identifies the list of variables. The program further includes code for receiving from the user via the GUI a selection of one or more of the variables from the list of identified variables. The selected one or more variables are used in determining the solution. The program still further includes code for obtaining confirmation from the user, via the GUI, of a business problem-specific parameter for use in determining the solution and displaying, via the GUI, a list of candidate analytical methods associated with the selected business problem. The GUI in this regard permits the user to select and/or confirm at least one of the candidate analytical methods. The program still further includes code for configuring the model according to (i) the selected variables, (ii) the at least one analytical method, and (iii) the business problem-specific parameter (if applicable to the selected business problem) and analyzing the input dataset in accordance with the configured model to determine an output dataset that defines the solution to the selected business problem.

The foregoing and other aspects, features, details, utilities, and advantages of the present disclosure will be apparent from reading the following description and claims, and from reviewing the accompanying drawings.

### BRIEF DESCRIPTION OF THE DRAWINGS

FIG. 1 is block diagram showing an embodiment of a computer system according to the present disclosure.

FIG. 2 is a diagrammatic and block diagram view illustrating the embodiment of FIG. 1 in layer form.

FIGS. 3-11D are exemplary screen displays generated by a graphical user interface (GUI) of the embodiment of FIG. 1.

FIG. 12 is a block and flowchart diagram view illustrating, in multi-tier form, aspects of the operation of the embodiment of FIG. 1.

### DETAILED DESCRIPTION

Before proceeding to a detailed description of embodiments of the instant disclosure, a general overview of its operation will first be set forth. As described in the Background, a user of statistical analysis information and reports may be a business person, who may not have the in-depth technical knowledge and/or experience in statistical mathematics, data manipulation, and/or programming languages of complicated statistical analysis programs (e.g., R, SAS, SPSS, Matlab, etc.). A computer system according to the present teachings is configured to facilitate—in a number of ways set forth below—the statistical analysis for a typical user. Embodiments of the present teaching have the advantage of allowing a user to conduct powerful data analysis that usually requires complicated statistical analysis programs, but with many of the technical requirements mentioned above either relaxed or eliminated. In many instances, the advances described herein can obviate the need for involvement of a professional user (e.g., technical expert).

In embodiments of the instant disclosure, a computer system includes analytics workbench logic, which may be software, that is stored in memory such that when executed by an electronic processor, allows the user to dynamically build a suitable model that can be executed to determine a solution to a business problem. The system is characterized in that it allows the user to interact with the system through a series of user-friendly displays (i.e., a graphical user interface (GUI)). The analytics workbench logic is configured to provide the user with straightforward options with guided selections, as well as recommendations in certain instances. Once the model has been configured (i.e., built), the processor analyzes an input dataset by executing the now-configured model to produce an output dataset. The output dataset represents the solution to the business problem. The system may produce a variety of easy-to-understand output formats (e.g., graphical and/or tabular) using the output dataset (i.e., the solution). The output formats may be provided via a visualization tool. A visualization tool may include for example, and without limitation, at least in part, commercially available software such as Tableau, available from Tableau Software, Inc.

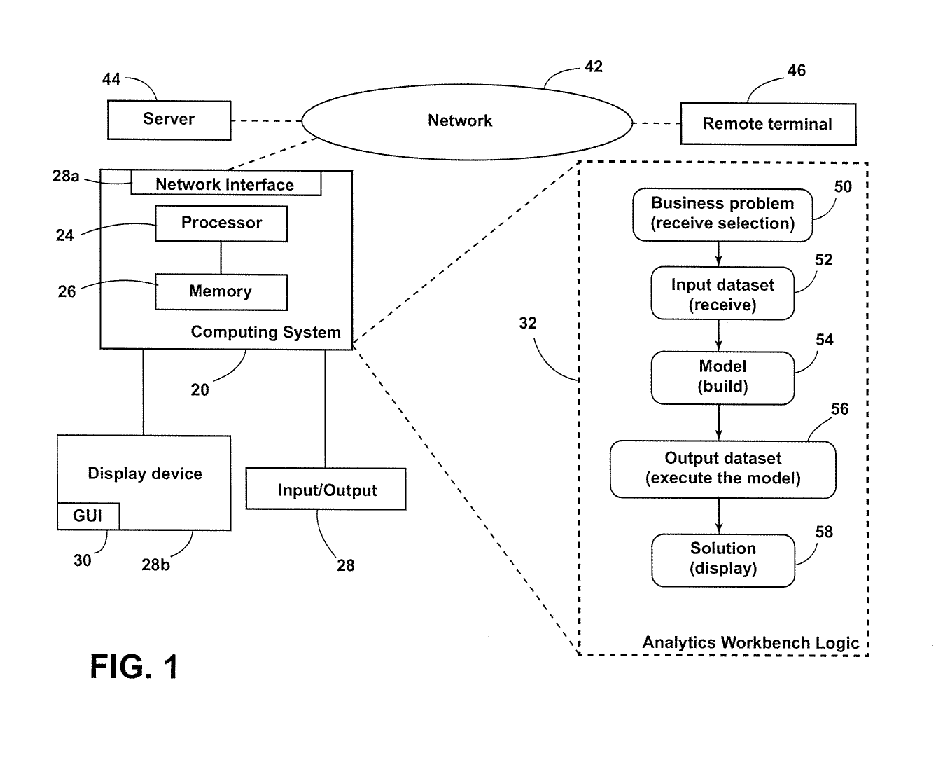

Referring now to the drawings, wherein like reference numerals are used to identify identical or similar components in the various views, FIG. 1 is a diagrammatic and block diagram view of a computer system 20 configured to allow a user 22 to dynamically build a model that is executed to determine a solution to a selected business problem. In the illustrated embodiment, the computer system 20 includes an electronic processor 24, a memory 26, a variety of input/output mechanisms 28 such as a network interface 28a, a display device 28b, as well as other I/O mechanisms known in the art (not shown in FIG. 1) such as a touchscreen, a microphone, a display device in addition to display device 28b, a speaker, a camera, a keyboard and a user selection device like a pointing device (e.g., a mouse or a trackpad). Display device 28b may be configured to display various interface elements as part of a graphic user interface (GUI) 30 to be described in greater detail below. FIG. 1 further shows analytics workbench logic 32, which in an embodiment comprises a computer program (i.e., a software application) including instructions/computer code for performing the various functions as described below. Analytics workbench logic 32 may be stored in non-transitory memory and/or loaded into memory 26 for execution by processor 24.

With continued reference to FIG. 1, processor 24 may be configured generally to control the overall operation of computer system 20, which may include controlling memory 26 and display device 28b, and execution of analytics workbench logic 32. For instance, overall control may be achieved through execution by one or more processors (only one shown) of a suitable computer system operating system. In embodiments, processor 24 may include one or more programmable processors, microprocessors, and/or microcontrollers. In addition, processor 24 may include a central processing unit (CPU), memory (in addition to or such as the illustrated memory 26) and an input/output (I/O) interface through which processor 24 may receive a plurality of input signals including signals generated via a graphical user interface (GUI) 30 and/or other input/output devices 28. Such an I/O interface may also be configured to generate a plurality of output signals including those used to control and/or provide data to display device 28b.

Memory 26 is provided for storage of data, instructions, and/or code (i.e., analytics workbench logic 32) and is coupled to at least processor 24. Memory 26 may include various forms of non-volatile (i.e., non-transitory) memory including flash memory, read only memory (ROM) including various forms of programmable read only memory (e.g., PROM, EPROM, EEPROM) and/or volatile memory including random access memory (RAM) including static random access memory (SRAM), dynamic random access memory (DRAM) and synchronous dynamic random access memory (SDRAM). Although illustrated as a separate component in the illustrated embodiment, it should be understood that memory 26 may be internal to processor 24.

Display device 28b may be configured to display aspects of GUI 30 generated by the operation of the analytics workbench logic 32. Display device 28b may function as an input/output device 28, as noted above, for the user 22 of computer system 20 and may include components known in the art. Display device 28b may be, for example only, a liquid crystal display or light emitting diode display or other technologies known in the art. Display device 28b may function as only an output device with input received through other I/O devices 28 such as a keyboard or mouse (not shown). Alternatively, display device 28b may also function as an input device and may include a touch screen display including, for example, capacitive and/or resistive touch screen displays, and/or other technologies known in the art.

Computer system 20 may be optionally connected to network 42 by way of network interface 28a. Network 42 may include, for example, an intranet (e.g., a LAN), the internet, a cellular network, and/or other networks. The network interface 28a permits analytics workbench logic 32 to be operated in accordance with a client-server model For example only, such a client-server model may involve deployment of a server 44, in communication with computer system 20, whose operation can be accessed by user 22 via remote terminal 46 (client).

With continued reference to FIG. 1, analytics workbench logic 32 implements a user-interface, including graphical user interface elements, that significantly ease or eliminate the technical knowledge requirements that can lessen the usefulness of conventional analytic computer programs from the non-technical user's perspective. In this regard, analytics workbench logic 32 may be configured generally to perform a series of operations, which will be briefly described below in turn.

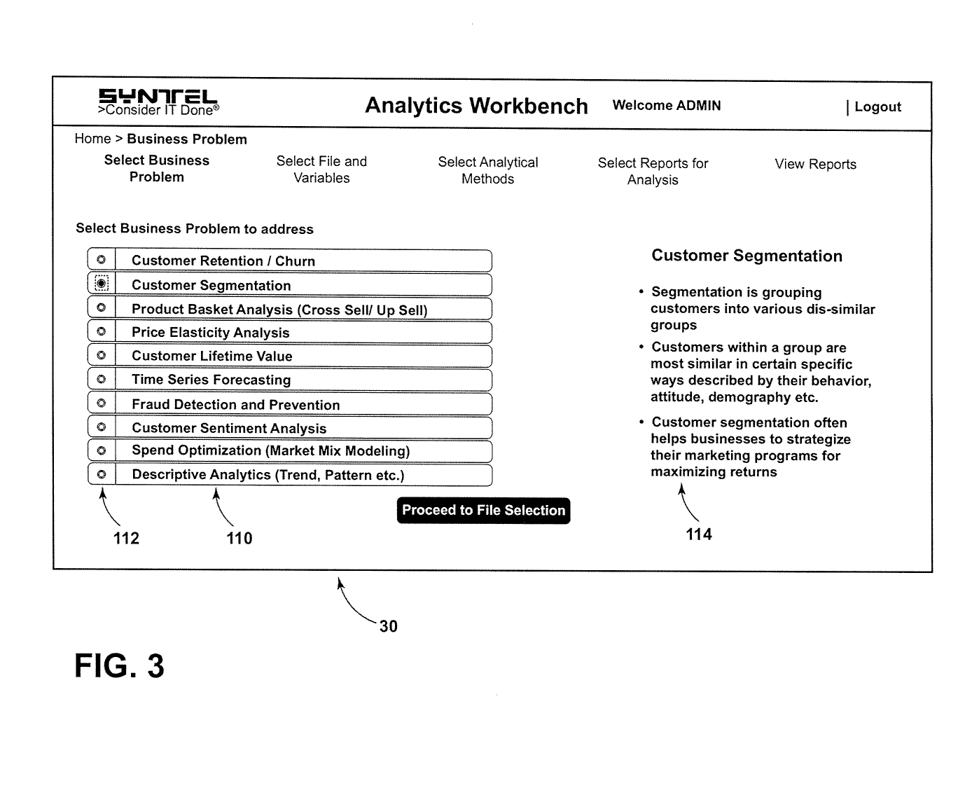

First, analytics workbench logic 32, via the GUI 30, is configured so at to allow the user 22 to select a business problem (the selected business problem 50). Analytics workbench logic 32 is also configured to then determine the solution to the selected business problem 50. Operation of GUI 30 in connection with user selection of the business problem is described in greater detail below in connection with FIG. 3.

Second, analytics workbench logic 32 is configured to receive, via interaction of the user 22 with GUI 30, an input dataset 52. In an embodiment, the input dataset 52 contains the data that is the subject of the analysis by analytics workbench logic 32.

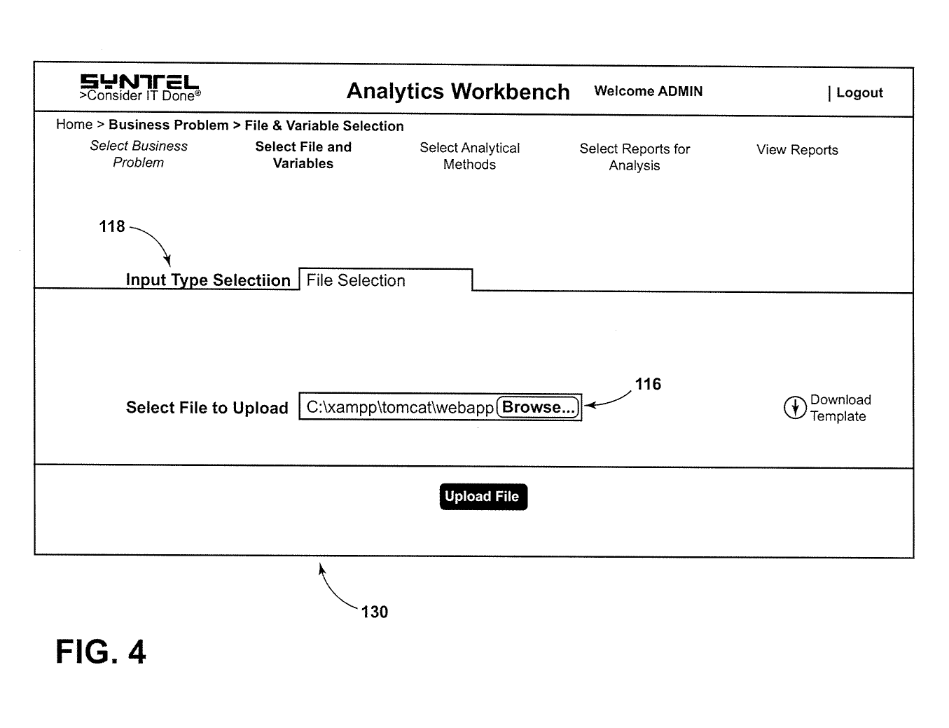

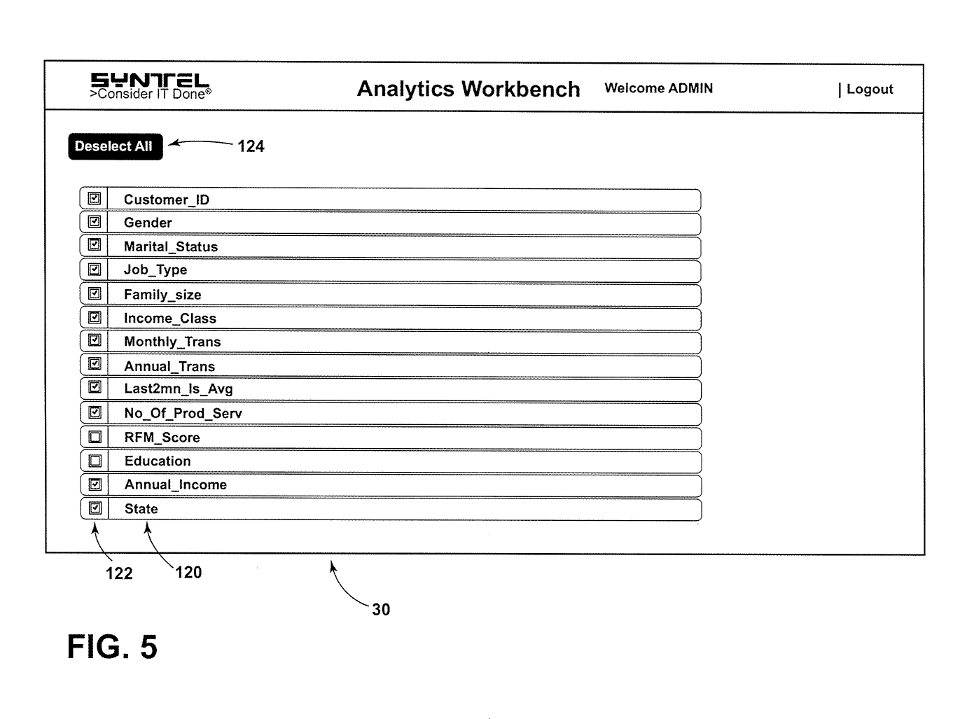

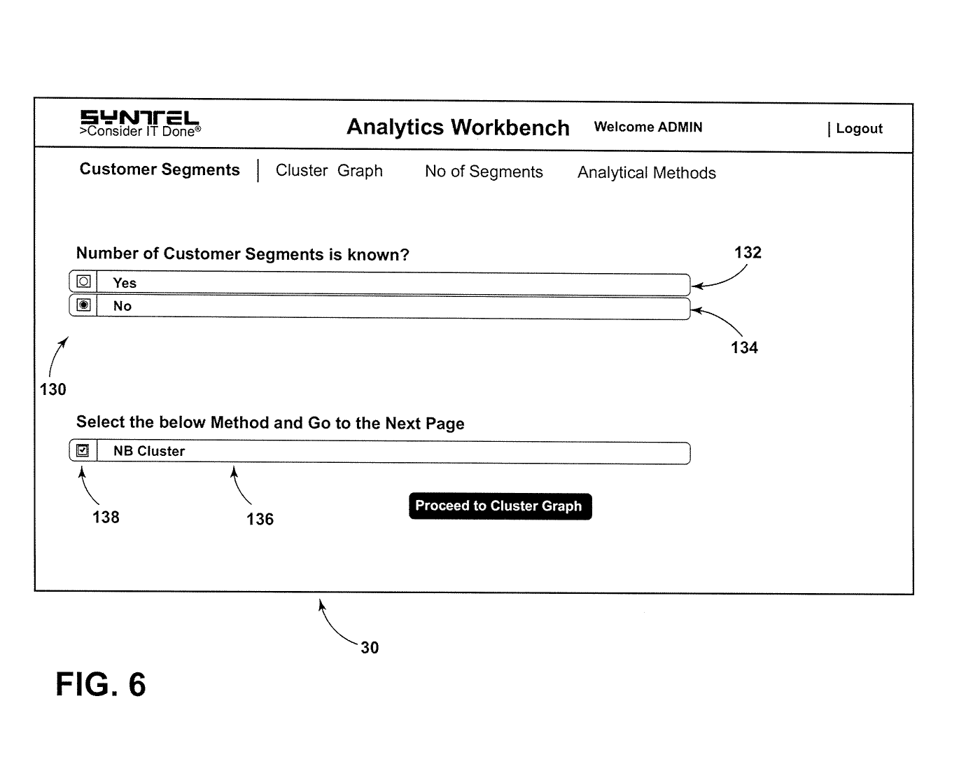

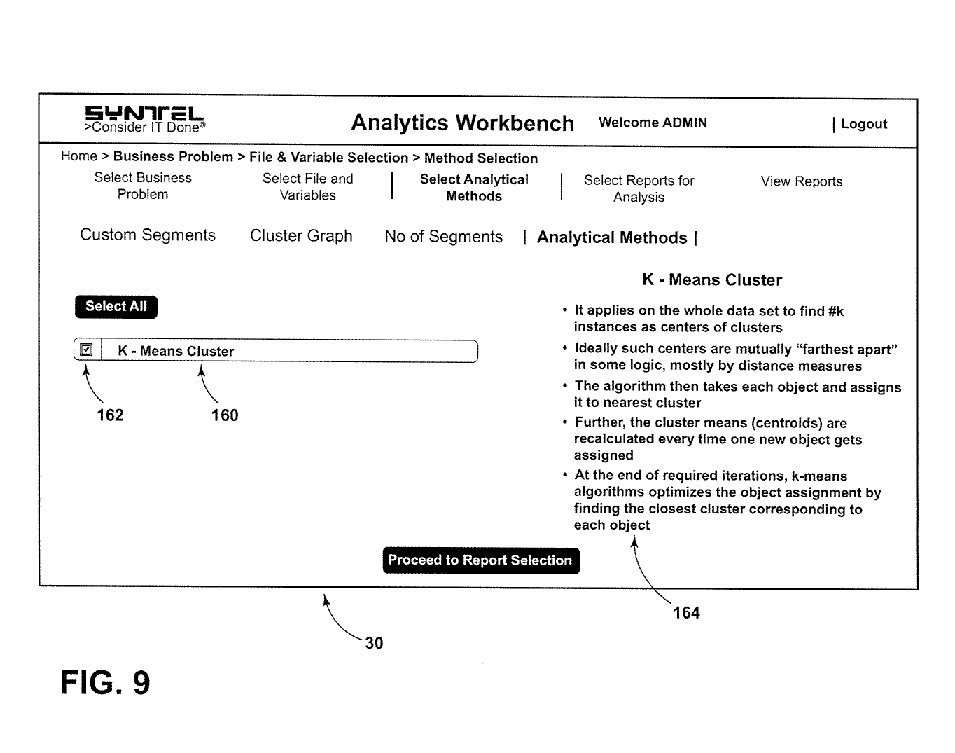

Third, analytics workbench logic 32, using inputs obtained from the user 22 as well as predetermined information, constructs an analysis model 54. For example only, the user's selection of the business problem to be solved (see FIG. 3), the user's identification of the input dataset to be analyzed (see FIG. 4), the user's selection of model variables (see FIG. 5), the user's specifying of a business problem-specific parameter for use in building the model 54 (see FIGS. 6-8), the user's specifying of the analytical method(s) to be used in the model 54 (see FIG. 9), may all be used in building the model 54.

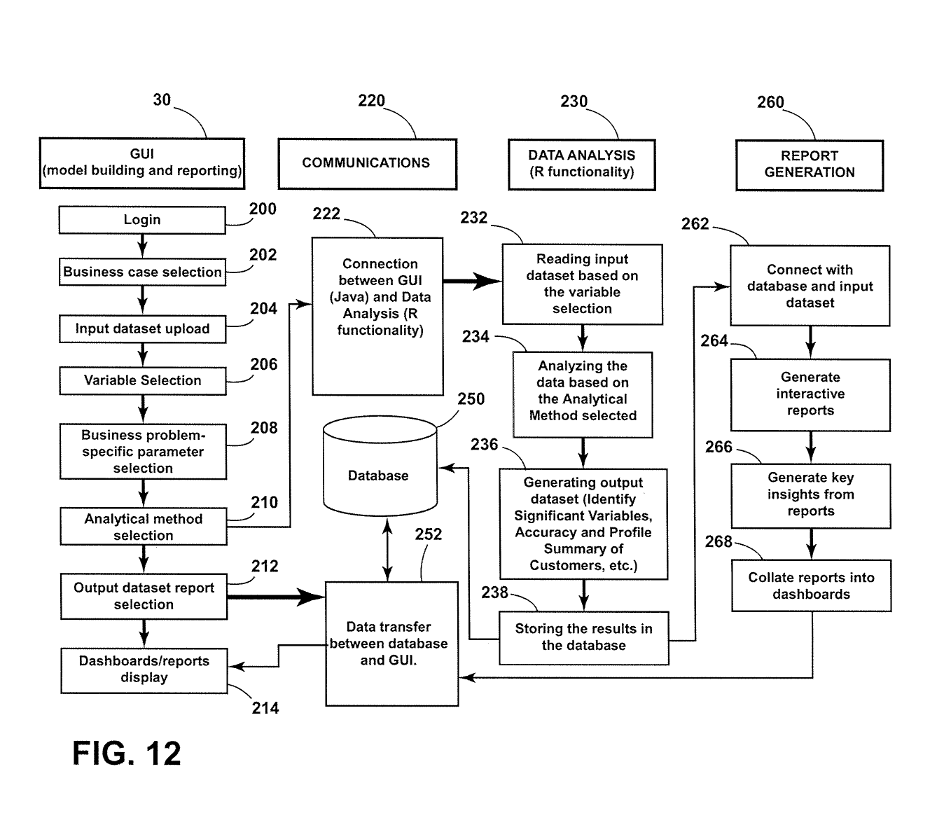

Fourth, analytics workbench logic 32 analyzes the input dataset 52 by executing the model 54 to produce an output dataset 56. Analysis of the input dataset 52 according to model 54 may be accomplished by a data analysis tier 230 described below (see FIG. 12). The output dataset 56 defines the solution to the selected business problem 50.

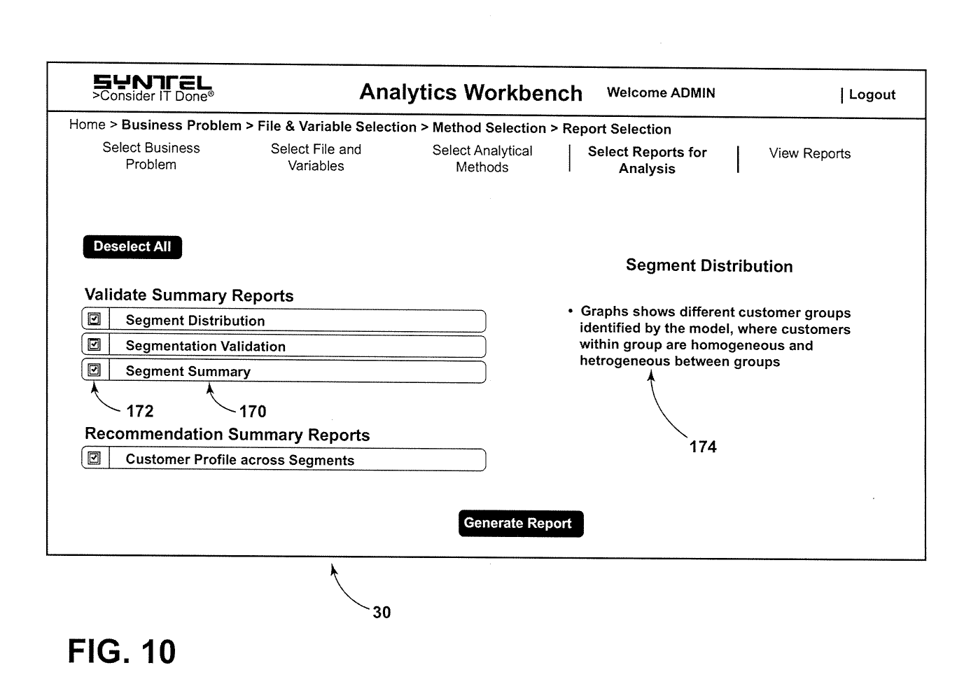

Fifth, analytics workbench logic 32, is configured to output the solution set (output dataset) in various user-specified formats (e.g., table format, scatter chart, bar chart, etc.). This will be described in greater detail below in connection with FIGS. 10-12.

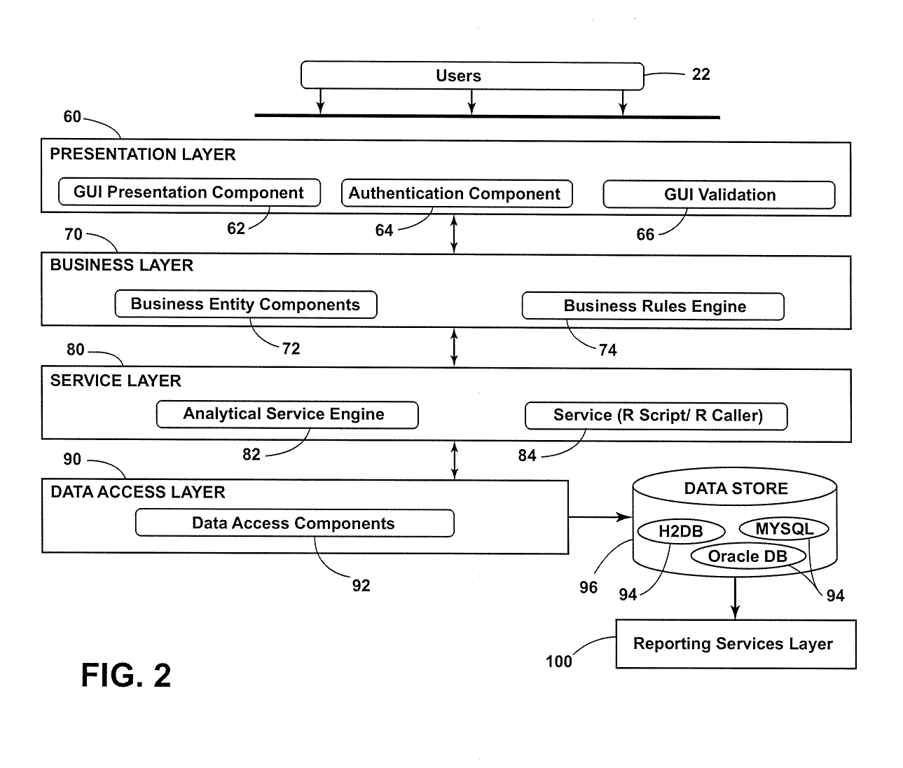

FIG. 2 is a diagrammatic and block diagram view illustrating the embodiment of FIG. 1 in layer form. In an embodiment, analytics workbench logic 32 may be implemented in an architecture including a plurality of logical layers. As shown, a presentation layer 60 is a layer that functions for interaction with users 22 at an interface (shown as a horizontal line). In the illustrated embodiment, presentation layer 60 may include a GUI presentation component 62, an authentication component 64, and/or a GUI validation component 66.

GUI presentation component 62 may be configured to generate GUI 30 for presentation to the user 22 via display device 28b. This function may include providing signals to display device 28b so that the desired presentation elements (e.g., windows, radio buttons, check boxes, etc.) may be viewed by and interacted with by the user 22. Authentication component 64 may be configured to request, receive, and verify authentication credentials from a user 22 to confirm that the user 22 is authorized to use analytics workbench logic 32. Authentication component 64 may comprise conventional components and methodologies and/or hardware now known or hereafter developed. In an embodiment, GUI validation 66 may be configured to validate a user or users via GUI by verifying stored predefined username and password, or multiple usernames and passwords for multiple users.

In embodiments, analytics workbench logic 32 may include a business layer 70 that may include business entity components 72 and/or a business rules engine 74. Business entity components 72 may include various parameters that may correspond to a particular business entity of a user. Business entity components 72 may validate an input dataset data to confirm that it corresponds to the particular business entity of a user and/or may include business logic to ensure data consistency or to implement business rules. Business rules may correspond to the types and/or formats of solutions for each business problem. For example, business rules engine may analyze data received from service layer 80, to verify that the data corresponds to the selected business problem. In embodiments, for customer segmentation business problem, business rules engine may analyze data received from services layer 80 and confirm that the data relates to characteristics of customer segments.

In embodiments, a service layer 80 may include an analytical service engine 82 and/or analytical services 84. An analytical service engine 82 may include one or more of a variety of statistical algorithms configured to analyze the input dataset 52 according to the selected business problem 50. In embodiments, analytical service engine may be specifically programmed with a discrete list of algorithms to apply to input dataset and/or may automatically select (e.g., without programming or additional input from a user) the appropriate algorithm or algorithms according to the business problem previously selected by the user.

In an embodiment, analytics workbench logic 32 may include a data access layer 90 that may include data access components 92. Data access components 92 may be configured to communicate with service layer 80 to receive output datasets 56 and to provide the output datasets 56 to a data store 96 for storage and reporting. In embodiments, data access components 92 may be configured to receive output dataset 56 generated by service layer 80 and store the output dataset 56 as a database 94 (e.g., a MYSQL database) in a data store 96.

A reporting services layer 100 may be configured to access the database 94 containing the output dataset 56 and present the output dataset 56 via the GUI 30 as a solution 58 in graphical and tabular forms using a visualization tool, such as, for example only, Tableau, for viewing by user 22.

As generally illustrated in FIGS. 3-11D, analytics workbench logic 32 is configured to present GUI 30 so as to provide a series of screen displays to the user 22 to present information and provide a facility to obtain and/or receive user input. The sequence of displays may be determined by the received user input.

Business Problem Selection.

As generally illustrated in FIG. 3, analytics workbench logic 32 is configured, via GUI 30, to generate a screen display (e.g., display via display device 28b) with a list of business problems 110, for presentation to the user 22. The list of business problems 110 may include those commonly used by a typical user or those chosen by a business according to identified use cases relevant for a particular business environment 22. For example only and without loss of generality whatsoever, a list of business problems 110 may include one or more of customer retention, customer segmentation, product basket analysis (e.g., cross selling, upselling, etc.), customer lifetime value, time series forecasting, fraud detection and prevention, customer sentiment analysis, spend optimization (e.g., market mix modeling), price band analysis (e.g., price optimization models), and descriptive analytics (e.g., trends, patterns, etc.). The analytics workbench logic 32, is further configured to receive from the user 22, also via GUI 30 through user selection of a radio button 112, the designation of a business problem from the complete list of candidate business problems. In an embodiment, only one business problem may be selected for analysis at a time.

In an embodiment, analytics workbench logic 32, via GUI 30, may be still further configured to display a details (description) section 114 for the currently-selected business problem 50. This section 114 may include a definition of business problem 50 and/or potential uses for solutions 58 to the business problem 50. For example only, if “Customer Segmentation” is selected by the user 22, analytics workbench logic 32 via GUI 30 may present the definition of a customer segmentation business problem and provide a description of what customer segmentation may be useful for (e.g., strategically for targeted marketing programs).

Customer Segmentation Use Case.

Without loss of generality, the remainder of the screen displays generally illustrated in FIGS. 5-11D will be described in connection with an embodiment where the business problem to be solved involves customer segmentation. The problem to be solved with customer segmentation is that of segmenting customer data into a plurality of different customer segments. Each segment includes a set of customers that share one or more similarly-valued attributes. In this regard, the above-described input dataset 52 may be organized as a matrix of customer data. Each row may be a customer profile and each column may be an attribute of the customer (e.g., age, income, etc.). These attributes may be referred to as variables. For customer segmentation, a particular business problem-specific parameter that may need to be defined is the number of customer segments. The solution to this problem may be an output dataset, where the output dataset includes at least a plurality of segments and a respective indication of the attribute values for those customers that were ultimately included in each segment. This will be described in more detail below.

Input Dataset.

In an embodiment, as generally illustrated in FIG. 4, the analytics workbench logic 32 via GUI 30 may be configured to present to the user 22 a dialog 116 configured to allow the user 22 to navigate (browse) through the file system to locate and select a data file containing the input dataset 52. The analytics workbench logic 32 is further configured to import the selected data file for further use. In an embodiment, the imported data file may be transformed and/or cleaned prior to uploading and/or prior to analysis. The data file may be of a conventional format, such as, without limitation, a *.csv format, an *.xls format, a *.txt format, or other file format now known or hereafter developed. The analytics workbench logic 32 via GUI 30 may be configured to present to the user 22 a dialog 118 configured to allow the user 22 to select the file type/format of the data file.

Selection of Variables from Input Dataset.

In an embodiment, as generally illustrated in FIG. 5, once user 22 has selected a business problem 50 and/or selected a data file containing the input dataset 52, analytics workbench 32 via GUI 30 may be configured to automatically present (e.g., without further input or action on the part of the user) a list of candidate variables 120 to user 22 for selection. The list of candidate variables 120 may correspond to variables that are present in the input dataset 52 that may have been previously uploaded by the user 22. In the illustrated embodiment, these variables are the variables that will be analyzed by analytics workbench logic 32 for purposes of determining customer segments. User 22 may be able to select one or more variables for analysis from the list (e.g., via check boxes 122). The analytics studio logic 32 is configured to process the input dataset 52 to identify the list of candidate variables 120 and to present, via GUI 30, the list to the user 22 for selection.

To reduce user burden, in an embodiment, analytics workbench logic 32 (via GUI 32) is configured to automatically select some or all of the variables 120 on the display and enable, via GUI 30, de-selection of one or more of the selected displayed variables 120. Analytics workbench logic 32, via GUI 32, may automatically select the variable or variables 120 that are most commonly selected (e.g., by previous users of the same company, or by other similar companies) for the selected business problem. Thus, two features are provided to reduce user burden, namely, (i) automatically generating the list of candidate variables 120 from the input dataset 52 and presenting the candidate variables, and (ii) automatically pre-selecting all the listed variables button for final selection. These features may therefore reduce the amount of input required from the typical user 22 (e.g., typical user 22 does not have to manually type in each variable, know a required syntax for doing so, or even know what variables are actually available in input dataset 52). Finally, the analytics workbench logic 32 via GUI 30 may be configured to accept a confirmation from the user 22 indicating that the displayed variables 120 that remain selected constitute the user's final selection. In this regard, clicking on the “Proceed” button may function as the user's confirmation of his/her final selection of variables.

Business Problem-Specific Parameter(s).

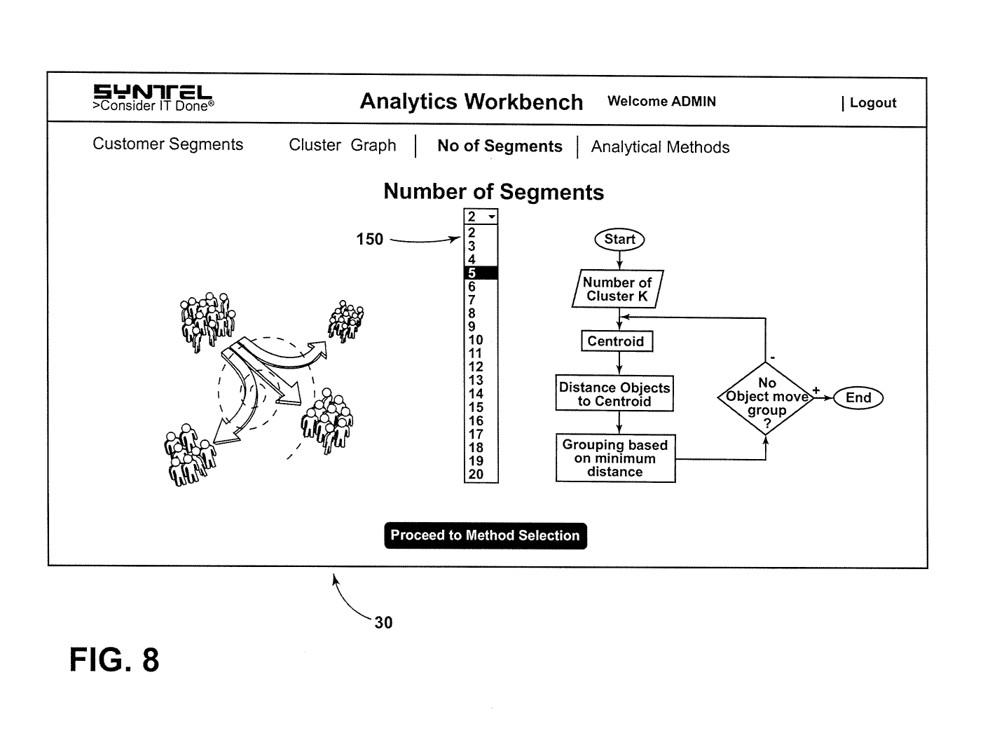

In embodiments, building model 54 for determining solution 58 to the selected business problem 50 may include receiving input from user 22 regarding a business problem-specific parameter. As generally illustrated in FIGS. 6-8, GUI 30 may present information 130 relating to a business problem-specific parameter for the selected business problem 50. For example only, building model 54 for the customer segmentation business problem may include receiving from the user 22 a number indicating the desired number of customer segments. Referring to FIG. 6, analytics workbench logic 32, via GUI 30, may present first and second options for selection by the user 22. First, if the user 22 knows the desired value for the business problem-specific parameter, GUI 30 may be configured to receive an input from the user 22 indicating that the value of the business problem-specific parameter is known, which may be via a radio button 132 corresponding to a “Yes” option. Referring to FIG. 8, if the business problem-specific parameter is known, GUI 30 may be configured to present a display to allow user 22 to directly enter the value for the parameter. In embodiments, user 22 may be able to enter the value of the parameter via a drop-down type box 150 by selecting a value from a discrete list of potential values. User 22 may then confirm that the currently selected and/or displayed value of the parameter is the user's final selection (e.g., via clicking on a “Next>” button). In embodiments, GUI 30 may only present values in the discrete list of potential values that makes business sense from an actual implementation point of view (e.g., that a corresponding analytical method is capable of receiving). Presenting only valid values may prevent user 22 from needing to know the range of valid values for the parameter, making building model 54 easier for user 22.

Referring again to FIG. 6, if user 22 does not know the desired value for the business problem-specific parameter, analytics workbench logic 32 may present a second option, which may permit user 22 to select a radio button 112 corresponding to a “No” option 134. analytics workbench logic 32, via GUI 30, may also be configured to help user 22 build model 54 by providing a recommended value of the parameter. First, GUI 30 may present to the user 22 a list of potential methods 136 for generating the recommendation. Second, user 22 can select one or more of such methods via checkboxes 138. In embodiments, the list of methods 136 may include only a single method and in this case the user 22 may simply confirm that the single available method should be used (e.g., by not unchecking the corresponding checkbox and clicking on the “Next>” button).

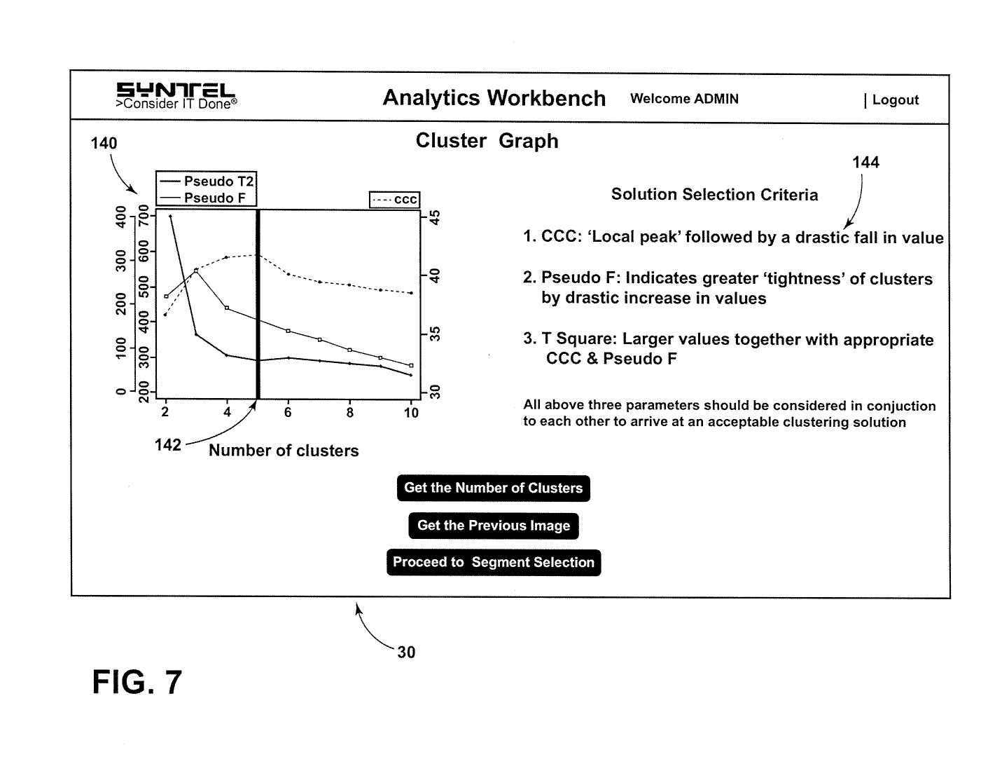

Referring to FIG. 7, once user 22 has indicated that the desired value is not known and user 22 has selected a recommendation method, analytics workbench logic 32 may be configured to analyze input dataset 52 according to the selected business problem 50. Then, logic 32 will provide the recommended value of the business problem-specific parameter. The recommended value may be presented via GUI 30 in a graphical format 140. For example only, as generally illustrated in FIG. 7, the recommended value for the number of segments (see the thick vertical line 142 disposed at “4” on the x-axis). GUI 30 may also include instructions 144 for user 22 for evaluating graphical recommendation 140. Referring again to FIG. 8, once user 22 has been presented with the recommended parameter value, GUI 30 may allow user 22 to specify the value in a similar manner as described above for the case where the user knows the parameter value.

In embodiments, analytics workbench logic 32, via GUI 30, may selectively display information 130 related to business problem-specific parameters. For example only, selected business problem 50 may not have any business problem-specific parameters, or not require separate input from user 22. For such selected business problems 50, analytics workbench logic 32 may be configured to omit displaying the screen displays shown in FIGS. 6-8. In other embodiments, selected business problem 50 may have a plurality of business problem-specific parameters. In such embodiments, GUI 30 may permit user 22 to indicate whether each parameter value is known (e.g., via a collection of radio buttons, checkboxes, and/or drop-downs, each corresponding to a parameter). If values for all parameters are known, GUI 30 may permit user 22 to enter each known value as described above. If values are not known for any of the parameters, analytics workbench logic 32 may provide a recommendation 140 for both parameters as generally described above in connection with FIGS. 6-8. If values for only some of the parameters are known, analytics workbench logic 32 may permit user 22 to enter known value(s) and may recommend values for the unknown value(s).

Selection of Analytical Method(s).

Referring to FIG. 9, building model 54 may include analytics workbench logic 32, via GUI 30, presenting a list of potential analytical methods 160 to user 22 (and asking for a selection). The list of candidate analytical methods 160 may be automatically determined by analytics workbench logic 32 according to selected business problem 50, the selected variables, and the business problem-specific parameter (e.g., certain analysis methods may not be available for the selected business problem, the selected variables, or for the selected value of the business problem-specific parameter). User 22 may then be able to select one or more of the analytical methods (e.g., via checkboxes 172 corresponding to each analytical method), which may be pre-selected, and confirm the selection is the user's final selection (e.g., via clicking on the “Next>” button). A list of analytical methods 160 may include a single method and user 22 may confirm a default selection of the single method. As noted above, the analytical methods may be implemented via a programming language designed for statistical analysis, such as, for example, R.

In embodiments, analytics workbench logic 32 may only be configured for implementing one analytical method at a time and may, via GUI 30, allow user 22 to select only one analytical method. In such an embodiment, analytics workbench logic 32, via GUI 30, may display the list of methods 160 via radio buttons (e.g., mutually exclusive selections) instead of check boxes 162. In other embodiments, analytics workbench logic 32 may be configured to implement multiple analytical methods and may, via GUI 30, allow user 22 to select for concurrent analysis. Concurrent analysis may include processor applying multiple analytical methods to input data concurrently or nearly concurrently. Concurrent analysis may, additionally or alternatively, include using more than one display device 28b or using portions of the same display device 28b for displaying the results corresponding to each analytical method, such as generally described below in connection with FIGS. 10-12.

In embodiments, analytics workbench logic 32, via GUI 30, may be configured to display a details section 164 for a currently-selected analytical method, such as an explanation of how an algorithm used to implement the method interacts with input dataset 52. For example only, if “K—Mean Cluster” is selected by user 22, analytics workbench logic 32 may be configured to present, via GUI 30, an information section 164 about the K-Means Cluster algorithm for viewing by user 22.

In embodiments, the available analytical methods are incorporated directly into analytics workbench logic 32 and analytics workbench logic 32 does not rely on a secondary statistical analysis program (e.g., SAS, SPSS, Matlab, etc.) for implementing the selected analytical method(s). Operating independently of a secondary statistical analysis program may at least two advantages. First, users 22 do not need to have in-depth technical knowledge and/or experience in statistics or mathematics, data manipulation, and/or programming languages of such secondary statistical analysis programs. Second, users 22 may be able to avoid needing to pay for expensive licenses for the secondary programs, many of which include extensive functionality beyond that used for common business problems. In such embodiments, analytics workbench logic 32 may be referred to as being fully integrated and/or including both the front end and the back end.

Solve.

In embodiments, once user 22 has selected one or more analytical methods, model 54 may be complete and analytics workbench logic 32 may analyze the input data according to the now-configured model 54 It should be appreciated that the model 54 will be a configured based on the selected business problem 50, the selected variables, the value of the business problem-specific parameters, and the selected analytical methods, to generate an output dataset 58 that defines a solution to selected business problem 50.

Produce Outputs (Solution).

In embodiments, analytics workbench logic 32 may be configured to provide the solution to user 22 in one or more of a variety of ways that are easy to understand. For example only, analytics workbench logic 32 may include one or more display options for displaying the solution via GUI 30. Referring to FIG. 10, analytics workbench logic 32, via GUI 30, may be configured to present a list of potential solution display options 170 to user 22 for selection (e.g., via checkboxes 172 corresponding to each display option), which may be preselected. User 22 may confirm that the selected display options are the user's final selections (e.g., via clicking on the “Next>” button).

In embodiments, the list of display options 170 may be automatically determined (e.g., without further input by the user) by analytics workbench logic 32 according to currently-configured model. For example only, certain display options may be unique to or not available for selected business problem 50, the selected variables, or for the selected value of the business problem-specific parameter, and analytics workbench logic 32 may only present the display options available for the currently-configured model. In embodiments, only a single display option may be available for certain model configurations and analytics workbench logic 32 may pre-select the single option and present the single option to user 22 for confirmation.

In embodiments, analytics workbench logic 32 may only be configured to present one display option at one time and radio buttons may be presented instead of checkboxes 172 for selecting a display option. In other embodiments, such as the embodiment illustrated in FIG. 10, multiple display options may be selected. If multiple display options are selected, analytics workbench logic 32, via GUI 30, may use more than one display device 28b or use portions of the same display device 28b (e.g., windows or panes) for displaying each display option. In embodiments, analytics workbench logic 32 may present, via GUI 30, a details section 174 that may provide information regarding the selected display options.

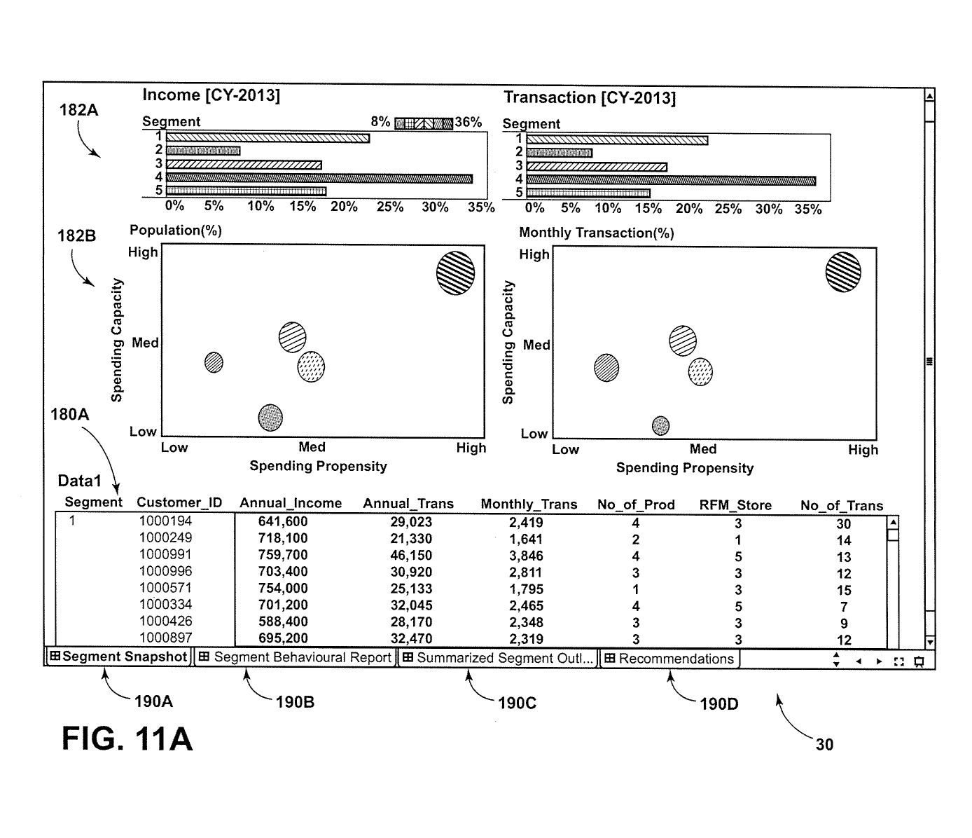

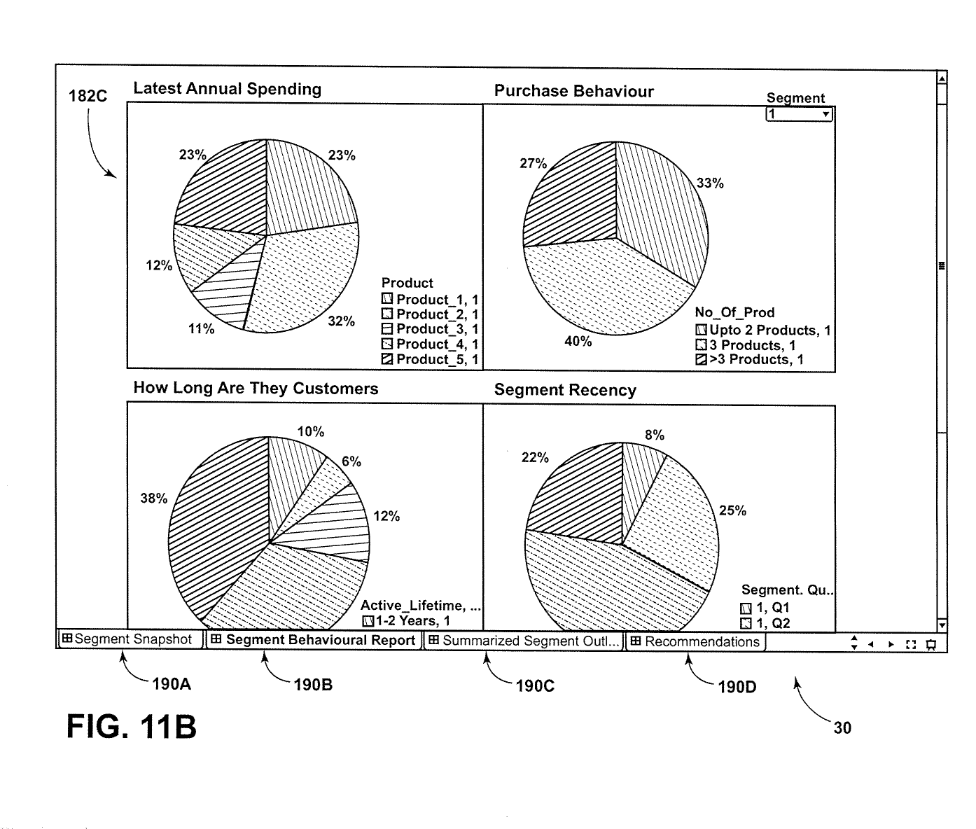

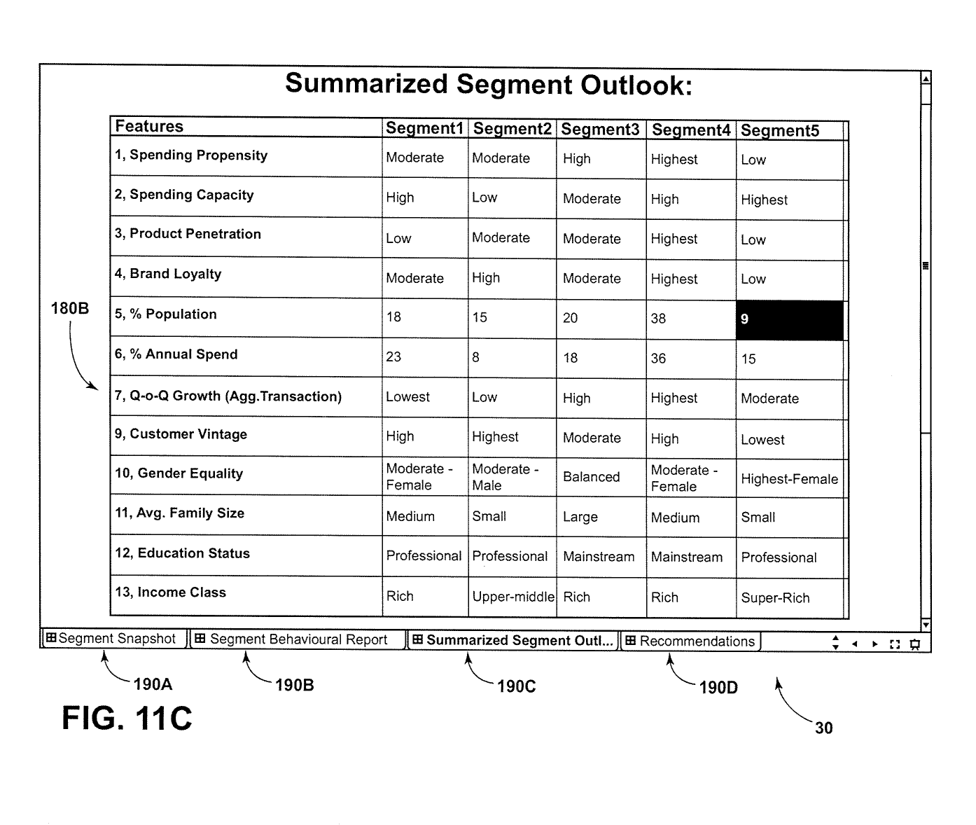

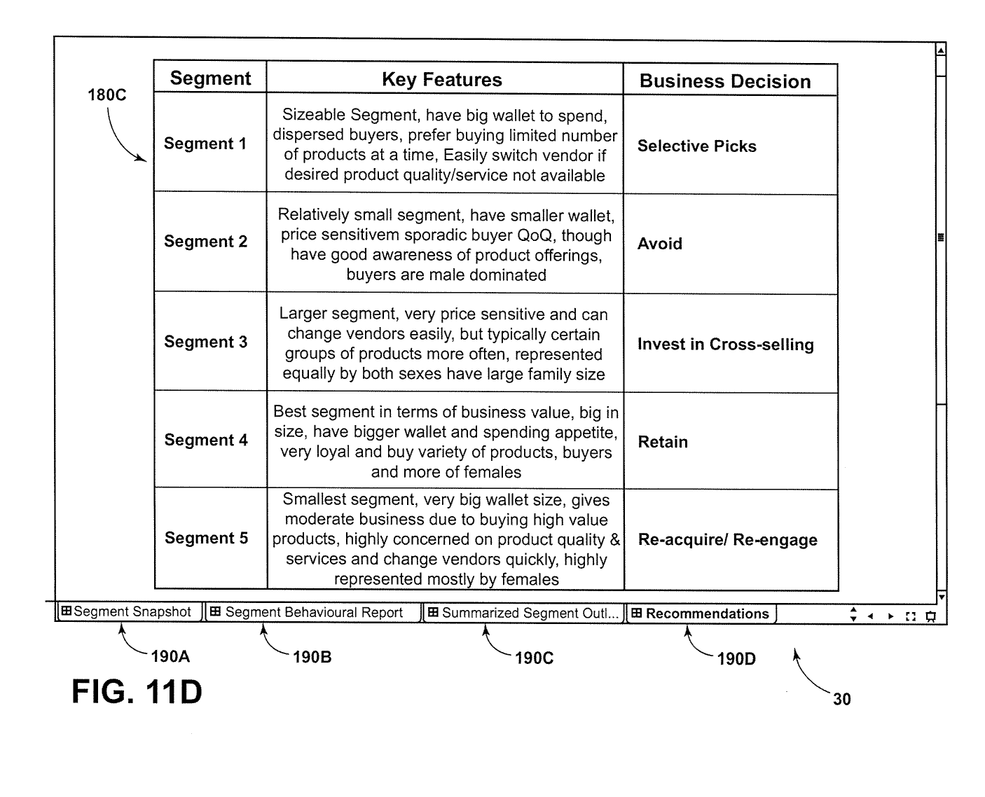

Referring to FIGS. 11A-11D, a solution display option of analytics workbench logic 32 may include a one or more tabular formats 180A-C, and other solution display options may include a one or more graphical formats 190A-C (e.g., bar chart, pie chart, line graph, scatter plot, etc.). The list of display options 170 may be provided automatically (e.g., user 22 does not need the technical knowledge to know which display options are available for the currently-configured model). Analytics workbench logic 32, via GUI 30, may automatically display the selected display option(s). Automatically displaying the options may allow user 22 to avoid interacting with output dataset 58 directly, but user 22 may still view the resulting solution to selected business problem 50 via graphical representations.

In embodiments, analytics workbench logic 32 may be configured to display the solution via one or more of tabs (e.g., tabs 190-190D). Each tab may include one or more display formats. For example, and without limitation, as generally illustrated in FIG. 11A, tab 190A may include tabular format 180A, graphical format 182A, and/or graphical format 182B. As generally illustrated in FIG. 11B, tab 190B may include several versions of graphical format 182C. As generally illustrated in FIG. 11C, tab 190C may include tabular format 180B. For a customer segmentation business problem, tabular format 180B may include a breakdown of each identified segment relative to the selected variables. As generally illustrated in FIG. 11D, tab 190D may include tabular format 180C. For a customer segmentation business problem, tabular format 180C may include analysis of each identified segment provided in the form of a textual summary. Tabular format 180C may, additionally or alternatively, provide a recommended business decision for some or all of the identified segments. For examples, recommended business decisions may include “Selective Picks,” “Avoid,” “Invest in Cross-selling,” “Retain,”, and/or “Re-acquire/Re-engage”. Providing such an analysis summary and/or business decision recommendation may further reduce a level of knowledge and/or understanding for a user to effectively analyze the input dataset and to make decisions based on that analysis.

Analytics workbench logic 32, via GUI 30, may be further configured to present a dialogue to allow the user 22 to change the selected value for the business problem-specific parameter (e.g., “re-specify”) and/or change the selected variables (e.g., “re-select”). If the user re-specifies the business problem-specific parameter(s) and/or re-selects the selected variable(s), analytics workbench logic 32 may reconfigure model 54 using the re-specified parameter(s) and/or re-selected variables, and then reanalyze the input dataset according to the re-configured model 54.

Implementation.

Referring to FIG. 12, an exemplary embodiment of an analytics workbench logic 32 is generally illustrated in a multi-tier form. As shown, analytics workbench logic 32 may include a first tier corresponding to GUI 30, a communications tier 220, and a data analysis tier 230. In blocks 200, 202, 204, 206, 208, 210, 212, an 214, as generally described above in connection with FIGS. 3-9, analytics workbench logic 32, via GUI 30, may display information to user 22 and receive information from user 22 to build a model for analyzing an input dataset (e.g., input dataset 52). In block 222, analytics workbench logic 32 may communicate data received via GUI 30 (e.g., input dataset, user selections, etc.) to data analysis tier 230. Such communication may involve interfacing between Java (e.g., for GUI 30) and R (e.g., for data analysis tier 230) programming languages. In blocks 232, 234, 236, and 238, analytics workbench logic 32 may analyze the input dataset according to information received via GUI 30 (e.g., via blocks 202-212) to generate an output dataset defining a solution to the selected business problem. In blocks 238 and 250, analytics workbench logic 32 may store the generated output (e.g., in block 236) in a database 250, such as a MYSQL database, an Oracle database, and/or an H2 database.

In report generation tier 260, which includes blocks 262, 264, 266, and 268, analytics workbench logic 32 may analyze/connect with the input dataset 52 and database 250 to generate interactive/dynamic reports (e.g., for display in formats 180A-C and/or 182A-C). In block 266, analytics workbench logic 32 may generate key insights from the reports to display in format 180C. In block 268, analytics workbench logic 32 may collate/combine a plurality of reports for a dashboard type display (e.g., as generally illustrated in FIGS. 11A-11D), which may include tabs (e.g., tabs 190A-D).

In blocks 212 and 214, as generally described above in connection with FIGS. 10-11D, analytics workbench logic 32, via GUI 30, may present report options for displaying the output dataset as a solution to user 22 for selection and may display the selected report options based on the output dataset stored in the database 250. In block 252, analytics workbench logic 32 may facilitate data transfer between database 250, data analysis tier 230, report generation tier 260, and GUI 30.

In embodiments, analytics workbench logic 32 may include code for carrying out the above. The code may include one or more programming languages. For example only, GUI 30 may be implemented via Java, and data analysis tier 230 may be implemented via R.

### Alternate Embodiment(s)

In other embodiments, analytics workbench logic 32 may be configured for implementation according to a desktop model. For example only, computer system 20 may be a standalone system, may include memory 26 on which analytics workbench logic 32 is stored, and may be directly coupled to display device 28b. The desktop model implementation of analytics workbench logic 32 via a standalone computer system may not include communication with other computer systems, such as server 44, or network 42, even if the standalone computer system is configured for such communication.

Simplified Model Building.

As described above, analytics workbench logic 32 is configured to provide typical users 22 a simplified method for building a model for statistical analysis. Analytics workbench logic 32 does not require users 22 to have significant knowledge regarding the input dataset, statistical algorithms, or programming languages. Analytics workbench logic 32 may be configured to receive straightforward selections (e.g., click, touch, etc.) from a relatively short list of options (e.g., less than 15 options). User 22 does not need to independently determine which options are applicable for the currently-configured model because analytics workbench logic 32 will automatically make those determinations. Similarly, user 22 also does not need to understand the intricacies of the algorithms used to implement the analytical methods. For example only, user 22 would not need to know required arguments, if any, for the algorithm, or the syntax that may be required for running the algorithm. In embodiments, analytics workbench logic 32 may be configured such that user 22 may provide each selection without direct entry of any characters. For example only, user 22 may be able to provide all requested input via pointing and clicking (e.g., via a mouse, touchpad, finger, gesture recognition, etc.) on options displayed via GUI 30, such as checkboxes, radio buttons, and/or drop downs.

It should be understood that a computer system 20 or a processor 24 as described herein may include a conventional processing apparatus known in the art, capable of executing pre-programmed instructions stored in an associated memory, all performing in accordance with the functionality described herein. To the extent that the methods described herein are embodied in software, the resulting software can be stored in an associated memory, such as memory 26, and can also constitute the means for performing such methods. Such a computer system 20 or processor 24 may further be of the type having both ROM, RAM, a combination of non-volatile and volatile (modifiable) memory so that any software may be stored and yet allow storage and processing of dynamically produced data and/or signals.

It should be further understood that an article of manufacture in accordance with this disclosure includes a non-transitory computer-readable storage medium having a computer program encoded thereon for implementing the analytics workbench logic 32 and other functionality described herein. The computer program includes code to perforin one or more of the methods disclosed herein. Such embodiments may be configured to execute one or more processors, multiple processors that are integrated into a single system or are distributed over and connected together through a communications network, and where the network may be wired or wireless.

It should be further understood that for references to a list or lists, the list or lists may include a single item (e.g., business problem, variable, parameter, etc.), or may include a plurality of items.

It should be further understood that while embodiments are described in connection with a customer segmentation business problem, analytics workbench logic 32 may include and/or be configured for analyzing a variety of other business problems commonly used by typical users 22 (e.g., business persons).

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

Although only certain embodiments have been described above with a certain degree of particularity, those skilled in the art could make numerous alterations to the disclosed embodiments without departing from the scope of this disclosure. Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. Additionally, the terms “communicate” and “communication” are meant to be construed broadly to encompass both wired and wireless connections and communications. It is intended that all matter contained in the above description or shown in the accompanying drawings shall be interpreted as illustrative only and not limiting. Changes in detail or structure may be made without departing from the invention as defined in the appended claims.

What is claimed is:

1. An article of manufacture, comprising:
a non-transitory computer storage medium having a computer program encoded thereon that when executed by a processor in a computer system dynamically configures a model for use in determining a solution to a business problem selected by a user wherein said user interacts with a graphical user interface (GUI) displayed on a display device connected to said computer system, said computer program including code for:
processing an input dataset having data organized according to a list of variables wherein said processing identifies said list of variables;
receiving from said user, via said GUI, a selection of one or more of said variables from said list of identified variables, said selected one or more variables for use in determining said solution;
obtaining confirmation from said user, via said GUI, of a business problem-specific parameter for use in determining said solution;
displaying, via said GUI, a list of candidate analytical methods associated with said selected business problem, wherein said GUI permits said user to select and/or confirm at least one of said candidate analytical methods;
configuring said model according to (i) said selected variables, (ii) said at least one analytical method, and (iii) said business problem-specific parameter; and
analyzing said input dataset in accordance with said configured model to determine an output dataset that defines said solution to said selected business problem.

2. The article of manufacture of claim 1, wherein said selected business problem comprises determining customer segments, each segment including customers that share one or more similarly-valued attributes, said variables of said input dataset comprising respective attributes of a plurality of customers where said input dataset data comprises attribute values, said business problem-specific parameter comprises the number of customer segments, and said output dataset comprises at least, for each determined segment, a respective indication of said attribute values for said customers included in that segment.

3. The article of manufacture of claim 1, wherein said computer program further includes code for:
displaying, via said GUI, a list of business problems; and
receiving from said user, via said GUI, a designation of one business problem from said displayed list of business problems.

4. The article of manufacture of claim 1, wherein said computer program further includes code for:
presenting, via said GUI, a dialog configured to allow said user to navigate a file system to locate and select said input dataset for importation from said file system.

5. The article of manufacture of claim 1, wherein receiving from said user a selection of one or more of said variables from said list of identified variables further includes:
automatically pre-selecting each variable on the display of said list of variables;
enabling, via said GUI, de-selection by said user of one or more of said pre-selected displayed variables; and
accepting a confirmation from said user, via said GUI, indicating that said displayed variables that remain selected constitute said user's final selection.

6. The article of manufacture of claim 1, wherein said computer program further includes code for:
receiving from said user, via said GUI, a selection of either (i) a first option indicating that said user will directly specify a value for said business problem-specific parameter; or (ii) a second option indicating that said user will specify the value for said business problem-specific parameter after being provided a recommendation for the value.

7. The article of manufacture of claim 6, wherein said computer program further includes code for:
determining said recommendation by analyzing said input dataset according to at least said selected variables; and
displaying to said user, via said GUI, said determined recommendation for the value of said business problem-specific parameter.

8. The article of manufacture of claim 1′, wherein said computer program further includes code for:
automatically pre-selecting, via said GUI, each one of said list of said displayed candidate analytical methods; and
allowing said user, via said GUI, to de-select one or more of said pre-selected candidate analytical methods; and
accepting a confirmation from said user, via said GUI, indicating that displayed candidate analytical methods that remain selected constitute said user's final selection.

9. The article of manufacture of claim 1, wherein said computer program further includes code for:
displaying, via said GUI, and automatically pre-selecting one or more solution output options available to said user;
allowing said user, via said GUI, to de-select one or more of said pre-selected solution output options; and
accepting a confirmation from said user, via said GUI, indicating that displayed solution output options that remain selected constitute said user's final selection.

10. The article of manufacture of claim 9, wherein said computer program further includes code for:
presenting, via said GUI, a dialog configured to allow said user to perform at least one of (i) re-specifying the value of said business problem-specific parameter; and (ii) re-selection of desired variables from said list of variable;
re-configuring said model using at least one of said re-specified value and re-selected variables; and
re-analyzing said input dataset using said re-configured model.

11. A computer system for configuring a model for use in determining a solution to a selected business problem, comprising:
a processor;
a memory;
a display device;
a computer program encoded on said memory that when executed by said processor dynamically configures a model for use in determining a solution to a business problem selected by a user interacting with a graphical user interface (GUI) displayed on said display device, the computer program including code for:
processing an input dataset having data organized according to the selected business problem, wherein said input dataset includes values corresponding to variables, said processing configured to identify a list of said variables from said input dataset;
processing an input dataset having data organized according to a list of variables wherein said processing identifies said list of variables;
receiving from said user, via said GUI, a selection of one or more of said variables from said list of identified variables, said selected one or more variables for use in determining said solution;
obtaining confirmation from said user, via said GUI, of a business problem-specific parameter for use in determining said solution when said selected business problem has an business problem-specific parameter associated therewith;
displaying, via said GUI, a list of candidate analytical methods associated with said selected business problem, wherein said GUI permits said user to select and/or confirm at least one of said candidate analytical methods;
configuring said model according to (i) said selected variables, (ii) said at least one analytical method, and (iii) when said selected business problem has said business problem-specific parameter associated therewith, said business problem-specific parameter; and
analyzing said input dataset in accordance with said configured model to determine an output dataset that defines said solution to said selected business problem.

12. The computer system of claim 11, wherein said selected business problem comprises determining customer segments, each segment including customers that share one or more similarly-valued attributes, said variables of said input dataset comprising respective attributes of a plurality of customers where said input dataset data comprises attribute values, said business problem-specific parameter comprises the number of customer segments, and said output dataset comprises at least, for each determined segment, a respective indication of said attribute values for said customers included in that segment.

13. The computer system of claim 11, wherein said computer program further includes code for:
receiving from said user, via said GUI, a selection of either (i) a first option indicating that said user will directly specify a value for said business problem-specific parameter; or (ii) a second option indicating that said user will be specify the value for said business problem-specific parameter after being provided a recommendation for the value.

14. The computer system of claim 11, wherein said selected business problem comprises determining customer segments, each segment including customers that share one or more similarly-valued attributes, said variables of said input dataset comprising respective attributes of a plurality of customers where said input dataset data comprises attribute values, said business problem-specific parameter comprises the number of customer segments, and said output dataset comprises at least, for each determined segment, a respective indication of said attribute values for said customers included in that segment.

15. A method for analyzing an input dataset via a graphical user interface (GUI) according to a business problem selected by a user via said GUI, the method comprising:
processing an input dataset having data organized according to a list of variables wherein said processing identifies said list of variables;
receiving from said user, via said GUI, a selection of one or more of said variables from said list of identified variables, said selected one or more variables for use in determining said solution;
obtaining confirmation from said user, via said GUI, of a business problem-specific parameter for use in determining said solution when said selected business problem has an business problem-specific parameter associated therewith;
displaying, via said GUI, a list of candidate analytical methods associated with said selected business problem, wherein said GUI permits said user to select and/or confirm at least one of said candidate analytical methods;
configuring said model according to (i) said selected variables, (ii) said at least one analytical method, and (iii) when said selected business problem has an business problem-specific parameter associated therewith, said business problem-specific parameter; and
analyzing said input dataset in accordance with said configured model to determine an output dataset that defines said solution to said selected business problem.

16. The method of claim 15, comprising:
receiving from said user, via said GUI, a selection of either (i) a first option indicating that said user will directly specify a value for said business problem-specific parameter; or (ii) a second option indicating that said user will be specify the value for said business problem-specific parameter, when said selected business problem has an business problem-specific parameter associated therewith, after being provided a recommendation for the value.

17. The method of claim 16, comprising:
determining said recommendation by analyzing said input dataset according to at least said selected variables; and
displaying to said user, via said GUI, said determined recommendation for the value of said business problem-specific parameter in a graph format.

18. The method of claim 15, comprising:
presenting, via said GUI and after displaying said recommendation, a dialog configured to allow said user to perform at least one of (i) re-specifying the value of said business problem-specific parameter; and (ii) re-selection of desired variables from said list of variable;
re-configuring said model using at least one of said re-specified value and re-selected variables; and
re-analyzing said input dataset using said re-configured model.

19. The method of claim 15, comprising:
displaying, via said GUI, and automatically pre-selecting one or more solution output options available to said user;
allowing said user, via said GUI, to de-select one or more of said pre-selected solution output options; and
accepting a confirmation from said user, via said GUI, indicating that displayed solution output options that remain selected constitute said user's final selection.

20. The method of claim 15, comprising:
automatically pre-selecting each variable on the display of said list of variables;
enabling, via said GUI, de-selection by said user of one or more of said pre-selected displayed variables; and
accepting a confirmation from said user, via said GUI, indicating that said displayed variables that remain selected constitute said user's final selection.
